(19) United States
(12) Patent Application Publication
(10) Pub. No.: US 2017/0203445 A1
(43) Pub. Date: Jul. 20, 2017

(54) ROBOT AND ROBOT SYSTEM

(71) Applicant: Seiko Epson Corporation, Tokyo (JP)

(72) Inventors: Takuya OWA, Matsumoto (JP); Yuta SATO, Azumino (JP)

(21) Appl. No.: 15/405,676

(22) Filed: Jan. 13, 2017

(30) Foreign Application Priority Data
Jan. 19, 2016 (JP) 2016-007672

(51) Int. Cl. B25J 19/00

(52) U.S. Cl. CPC B25J 19/0054

(57) ABSTRACT

A robot includes a heat generating member and a heat transfer member detachably provided on the heat generating member, wherein the heat transfer member has a first part located outside of the robot.

### BACKGROUND

### 1. Technical Field

The present invention relates to a robot and a robot system.

### 2. Related Art

To improve the operating speed performance of robots, measures for heat radiation of motors are important. Depending on the usages of the robots, heat generation may not be problematic. For example, in the case where the load is light and the operation is slow (e.g. sealing work, deburring work, or the like) and the case where the load is momentarily heavy, but there are many intermissions and the average load is lower (assembly work or the like), the heat generation is less problematic. On the other hand, in the fast and simple transportation, the average load of the motors is higher and the heat generation may be problematic.

In robots of related art, cooling devices that effectively cool motors provided within bases to suppress temperature rises due to heat generation of the motors, and thereby, may keep the operating performance of the motors higher are provided (for example, see Patent Document 1 (JP-A-10-337685)).

However, in Patent Document 1, it is necessary to prepare a space for attachment of a fan in advance and the casing of the robot becomes larger. Further, the fan is attached inside and detachment of the fan after installation of the robot may be difficult.

### SUMMARY

An advantage of some aspects of the invention is to solve at least a part of the problems described above, and the invention can be implemented as the following forms or application examples.

### APPLICATION EXAMPLE 1

A robot according to the application example is a robot including a heat generating member, and a heat transfer member detachably provided on the heat generating member, wherein the heat transfer member has a first part located outside of the robot.

According to this application example, in the case where heat generation of the heat generating member is problematic, heat dissipation performance may be improved after installation.

### APPLICATION EXAMPLE 2

In the robot according to the application example, it is preferable that the heat generating member is a motor.

According to this application example, the temperature rise of the motor may be suppressed.

### APPLICATION EXAMPLE 3

In the robot according to the application example, it is preferable that a cooling member detachably provided on the heat transfer member is provided.

According to this application example, the heat dissipation performance of the heat transfer member may be further improved.

### APPLICATION EXAMPLE 4

In the robot according to the application example, it is preferable that the cooling member includes a heat sink.

According to this application example, the heat transmitted from the heat generating member to the heat transfer member may be dissipated more positively from the heat sink.

### APPLICATION EXAMPLE 5

In the robot according to the application example, it is preferable that the cooling member includes a fan.

According to this application example, forceful ventilation is performed, and thereby, the heat generating member that generates a large amount of heat may be efficiently cooled.

### APPLICATION EXAMPLE 6

In the robot according to the application example, it is preferable that a base and an arm provided on the base are provided, and the heat generating member is provided inside of the base.

According to this application example, the thermal expansion of the base significantly affects the displacement of the arm tip end, and the displacement of the arm tip end may be suppressed by cooling of the heat generating member for suppression of the thermal expansion of the base.

### APPLICATION EXAMPLE 7

In the robot according to the application example, it is preferable that the heat transfer member has a first heat transfer member and a second heat transfer member, and the first heat transfer member is a heat transfer sheet in contact with the heat generating member.

According to this application example, the heat of the heat generating member may be efficiently propagated to the second heat transfer member side by the heat transfer sheet.

### APPLICATION EXAMPLE 8

In the robot according to the application example, it is preferable that a sealing member is provided, and the sealing member is provided between a casing of the robot and the second heat transfer member.

According to this application example, higher thermal protection performance may be obtained with dust-proof and water-proof functions of the casing kept.

### APPLICATION EXAMPLE 9

In the robot according to the application example, it is preferable that a power source is provided, and the power source supplies electric power to the cooling member and another member.

According to this application example, the cooling member is easily attached to and detached from the second heat transfer member. Further, it is not necessary to newly and additionally provide a power source for the cooling member outside. Furthermore, the cooling member may be placed close to the heat generating member, and thereby, higher heat dissipation performance may be obtained.

### APPLICATION EXAMPLE 10

A robot according to this application example is a robot including a cooling member detachably provided outside of the robot.

According to this application example, in the case where heat generation of the heat generating member is problematic, heat dissipation performance may be improved after installation.

### APPLICATION EXAMPLE 11

A robot system according to this application example includes the robot according to one of the above described application examples and a control apparatus that controls the robot.

According to this application example, in the case where heat generation of the heat generating member is problematic, heat dissipation performance may be improved after installation.

### BRIEF DESCRIPTION OF THE DRAWINGS

The invention will be described with reference to the accompanying drawings, wherein like numbers reference like elements.

FIG. 1 is a perspective view of a configuration of a robot system of an embodiment.

FIG. 2A shows a state in which a cover is attached to a base of the embodiment, and FIG. 2B shows the base of the embodiment as seen from the top downward.

FIG. 3 shows the base of the embodiment as seen from the right leftward.

FIG. 4 is a perspective view of a state in which the cover is detached from the base of the embodiment.

FIG. 5 shows a motor unit of the embodiment as seen from the right leftward.

FIG. 6 shows the base of the embodiment as seen from the back frontward.

FIG. 7A shows a base of modified example 1 from the back frontward, and FIG. 7B shows the base of modified example 1 from the top downward.

FIG. 8 shows a base of modified example 2 from the top downward.

FIG. 9 a perspective view showing a state in which a protective cover member is attached to a base of modified example 6.

FIG. 10A shows the base of modified example 6 from the back frontward, and FIG. 10B shows the base of modified example 6 from the top downward.

### DESCRIPTION OF EXEMPLARY EMBODIMENTS

As below, embodiments of the invention will be explained according to the drawings. Note that, in the drawings for use, the parts to be explained are enlarged or reduced as appropriate for recognition.

### Robot System

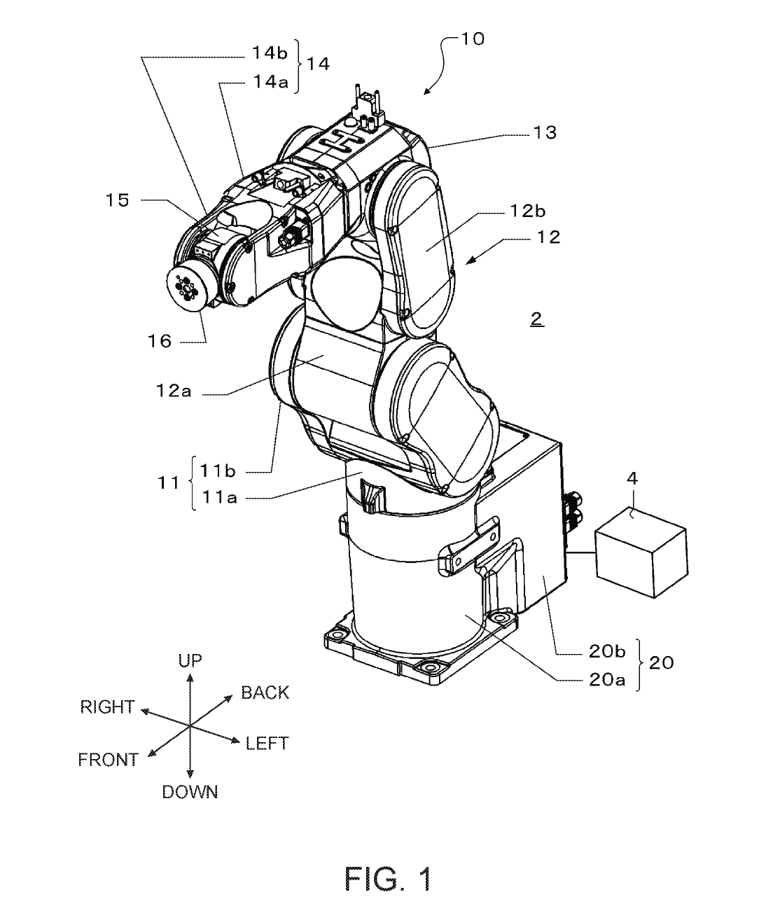

FIG. 1 is a perspective view of a configuration of a robot system 2 of an embodiment.

As shown in FIG. 1, the robot system 2 of the embodiment includes a robot 10 and a control apparatus 4. The control apparatus 4 controls the robot 10 according to a program input in advance to perform a predetermined work specified by the program.

### Configuration of Robot

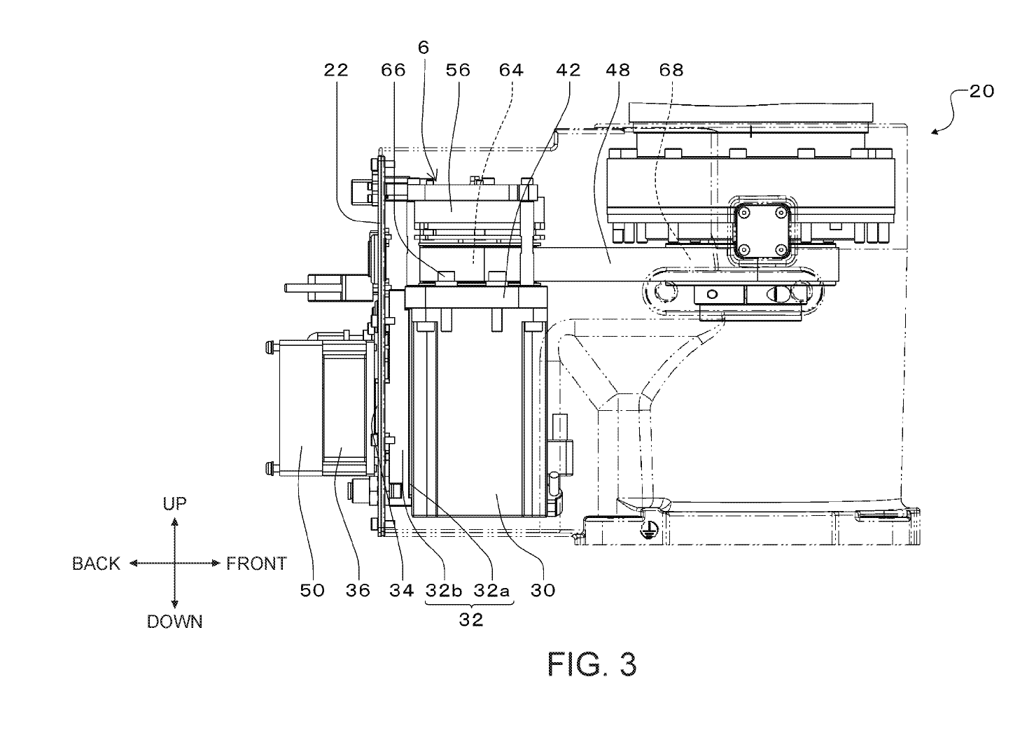

The robot 10 of the embodiment includes a plurality of arms 11 to 16 and a base 20. In the specification, the arms are sequentially numbered from the base 20 side for distinction. That is, the first arm 11 is rotatably supported by the base 20, the second arm 12 is rotatably supported by the first arm 11. Further, the third arm 13 is rotatably supported by the second arm 12, the fourth arm 14 is rotatably supported by the third arm 13, the fifth arm 15 is rotatably supported by the fourth arm 14, and the sixth arm 16 is rotatably supported by the fifth arm 15. The rotations of the respective arms are realized by a motor unit 6 (see FIG. 3) provided inside of the base 20, motors (not shown) provided inside of the arms, or the like. Note that, in the embodiment, an end effector (not shown) can be attached to the sixth arm 16.

In FIG. 1, the base 20 is placed in an installation location and fastened to the installation location using bolts or the like, and thereby, the robot 10 is installed. In the specification, directions are associated and shown in FIG. 1 such that the directions perpendicular to the surface on which the base 20 is installed are upward and downward directions and the direction in which the main drive ranges of the respective arms exist in the surface on which the base 20 is installed is a forward direction. Hereinafter, upward, downward, frontward, backward, leftward, and rightward directions refer to the directions shown in FIG. 1.

The base 20 has a schematic shape in which a main body 20a having a nearly cylindrical shape and a rectangular unit 20b having a nearly rectangular shape are coupled. In FIG. 1, the main body 20a in placed in front and the rectangular unit 20b is placed in back. On the main body 20a, the first arm 11 is supported by the main body 20a to be rotatable about a rotation axis extending in the upward and downward directions in FIG. 1 as a rotation center. The first arm 11 includes a main body 11a and a supporting part 11b, and is supported by the base 20 with the main body 11a placed on the main body 20a of the base 20. The supporting part 11b is a part that nips and supports the second arm 12. The second arm 12 includes a main body 12a and a supporting part 12b, and is supported by the supporting part 11b so that the main body 12a may be rotatable about a rotation axis extending in the leftward and rightward directions in FIG. 1 as a rotation center with the main body nipped by the supporting part 11b. The supporting part 12b is a part that nips and supports the third arm 13.

The third arm 13 has a nearly rectangular parallelepiped shape, and is supported by the supporting part 12b so that the third arm 13 may be rotatable about a rotation axis extending in the leftward and rightward directions in FIG. 1 as a rotation center with the third arm 13 nipped by the supporting part 12b. The fourth arm 14 is supported by an end surface of the third arm 13 (the end surface on the front side in the state shown in FIG. 1) so that the fourth arm 14 may be rotatable about a rotation axis parallel to a direction (the frontward and backward directions in the state shown in FIG. 1) perpendicular to the rotation axis of the third arm 13 (in the leftward and rightward directions in the state shown in FIG. 1).

The fourth arm 14 includes a main body 14a and a supporting part 14b, and is supported by the third arm 13 so that the main body 14a may be rotatable about a rotation shift extending in the frontward and backward directions in FIG. 1 as a rotation center. That is, in the embodiment, the direction in which the fourth arm 14 extends and the direction in which the rotation axis extends are parallel and the fourth arm 14 can twist. The supporting part 14b is a part that nips and supports the fifth arm 15. The fifth arm 15 is supported by the supporting part 14b to be rotatable about a rotation axis extending in the leftward and rightward directions in FIG. 1 as a rotation center with the fifth arm 15 nipped by the supporting part 14b. Further, the sixth arm 16 is supported by the fifth arm 15 to be rotatable about a rotation axis extending in the frontward and backward directions in FIG. 1 as a rotation center. That is, the sixth arm 16 is also adapted to twist.

To the base 20, a plurality of cable routings for transmission of signals, fluids (air) to the other parts can be connected. That is, these cable routings are connected to the base 20 and the cable routings are routed inside of the base 20, and thereby, electric power, signals, fluids, etc. are transmitted to the base 20 and an arbitrary arm of the first arm 11 to the sixth arm 16 and used.

### Configuration of Cover

In the embodiment, a cable routing may be connected to a cover that can be attached to the base 20.

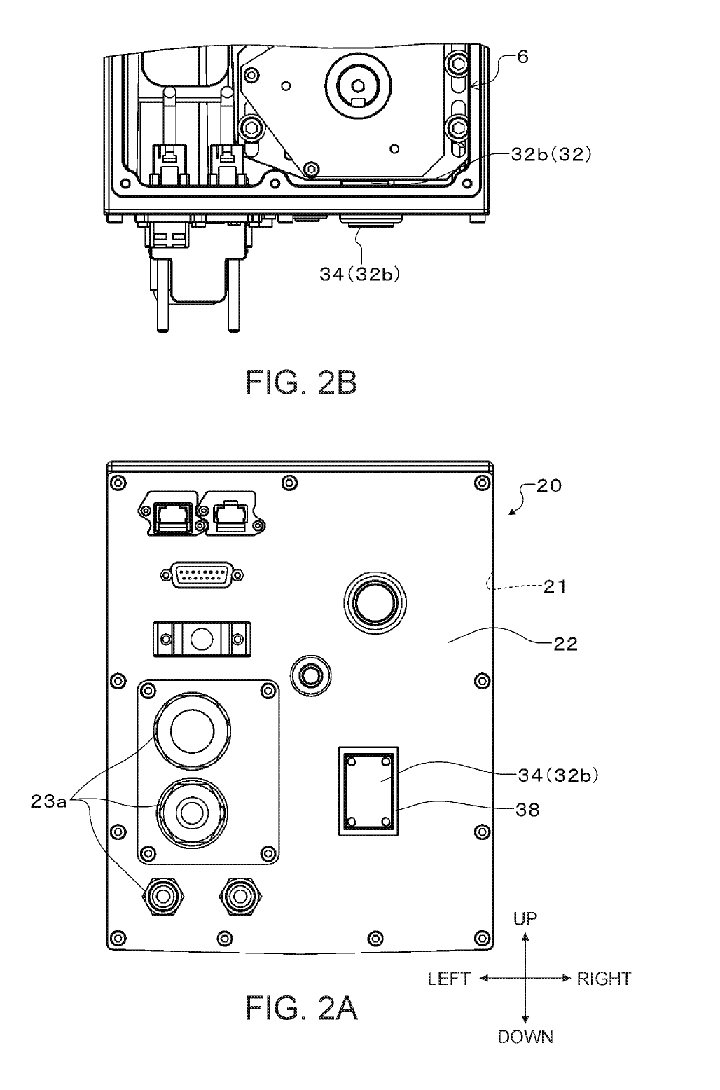

FIG. 2A shows a state in which a cover 22 is attached to the base 20 of the embodiment as seen from the back frontward, and FIG. 2B shows the base 20 of the embodiment as seen from the top downward. Note that, in FIG. 2B, illustration of an upper case of the base 20 is omitted.

In the base 20, an opening part 21 is formed in the side surface (back surface) of the rectangular unit 20b. The cover 22 can be attached to the opening part 21. Note that, in FIG. 2A, the opening part 21 is located behind the cover and shown by a broken lead line drawn from the part corresponding to the edge of the opening part 21.

The cover 22 is formed by a plate-like member having a nearly square shape and includes a plurality cable routing connecting portions 23a. Note that, in FIG. 2A, part of the plurality of cable routing connecting portions 23a provided in the cover 22 are shown by lead lines.

The shape of the opening part 21 is determined so that the cover 22 may be covered by the opening part 21 when the cover 22 is attached to the opening part 21. Therefore, in the state in which the cover 22 is attached to the base 20, the interior of the base 20 is not exposed.

On the inner diameter side of the periphery of the opening part 21, screw holes for insertion and fastening of screws are formed. On the other hand, in the cover 22, holes in which the screws can be inserted are formed in positions corresponding to the respective screw holes.

According to the configuration, the cover 22 can be attached to the opening part 21.

The cable routing connecting portions 23a provided in the cover 22 are members that can connect the cable routings existing inside of the base 20 and the connection destinations outside of the base 20. When the cable routings are conductors, the cable routing connecting portions 23a are connectors for ensuring conduction of the cable routings. When the cable routings are pipes, the cable routing connecting portions 23a are joints that may distribute the fluids in the pipes inside and outside.

According to the embodiment, the opening part 21 is covered by the cover 22, and thereby, flows of the fluids and objects inside and outside of the base 20 (e.g. leakage of oil from the base, entry of dirt into the base, etc.) may be prevented.

The robot 10 of the embodiment includes the motor unit 6 and a heat transfer member 32 detachably attached to the motor unit 6. The heat transfer member 32 includes a first part 34 located outside of the robot 10. Thereby, the temperature rise of the motor unit 6 may be prevented more reliably.

### Motor Unit

The motor unit 6 will be explained with reference to FIG. 3.

FIG. 3 shows the base 20 of the embodiment as seen from the right leftward. Note that a heat sink (cooling member) 36 is provided in the first part 34 of the heat transfer member 32, and a fan (cooling member) 50 is provided on the heat sink 36. Note that, in FIG. 3, the illustration of the upper case of the base 20 is omitted.

As shown in FIG. 3, the motor unit 6 of the embodiment includes a motor (heat generating member) 30, an electromagnetic brake 56, a motor pulley 64, and a motor plate 42. The motor 30 and the electromagnetic brake 56 are fixed to the motor plate 42 and the motor plate 42 is fixed to the base 20, and thereby, the motor unit 6 is fixed to the robot 10.

The motor 30 has a nearly cylindrical outer shape and includes an output shaft (not shown). The output shaft protrudes from one end of the nearly cylindrical shape of the motor 30. In the motor plate 42, a shaft hole (not shown) is formed. In a state in which the output shaft penetrates the shaft hole, an end surface of the motor 30 is in contact with the motor plate 42 and the motor 30 is fixed to the motor plate 42 by fixing members such as screws 66. An encoder (not shown) is fixed to an end surface opposite to the end surface of the motor 30 fixed to the motor plate 42.

The motor 30 shown in FIG. 3 has a casing elongated in one direction and attached within the base 20 with the longitudinal direction along the upward and downward directions. The motor 30 includes the output shaft protruding upward in the vertical direction and the motor pulley 64 is attached to the output shaft. Further, a belt 48 is looped over the motor pulley 64, and the rotation of the motor pulley 64 is transmitted to a rotation shaft member pulley 68 via the belt 48.

On an opposite surface to which the motor 30 is fixed in the motor plate 42, the electromagnetic brake 56 is provided. A member forming the electromagnetic brake 56 is fixed to the motor plate 42 or the output shaft protruding through the shaft hole, and thereby, the electromagnetic brake 56 is fixed to the motor plate 42.

The electromagnetic brake 56 that suppresses the rotation of the output shaft is attached to the upper end of the output shaft. In the embodiment, the electromagnetic brake 56 is attached to the upper end of the output shaft using a bolt (not shown) and a cable routing as a communication line and an electric power line (not shown) is attached thereto. That is, when a signal as an instruction of suppressing the rotation of the output shaft is transmitted to the electromagnetic brake 56 by the cable routing, the electromagnetic brake 56 is driven by the electric power and exerts a friction force on the member connected to the output shaft. As a result, the rotation of the output shaft is suppressed. According to the configuration, in the robot 10, the rotation of the output shaft in the motor 30 can be stopped (or suppressed) at an arbitrary time.

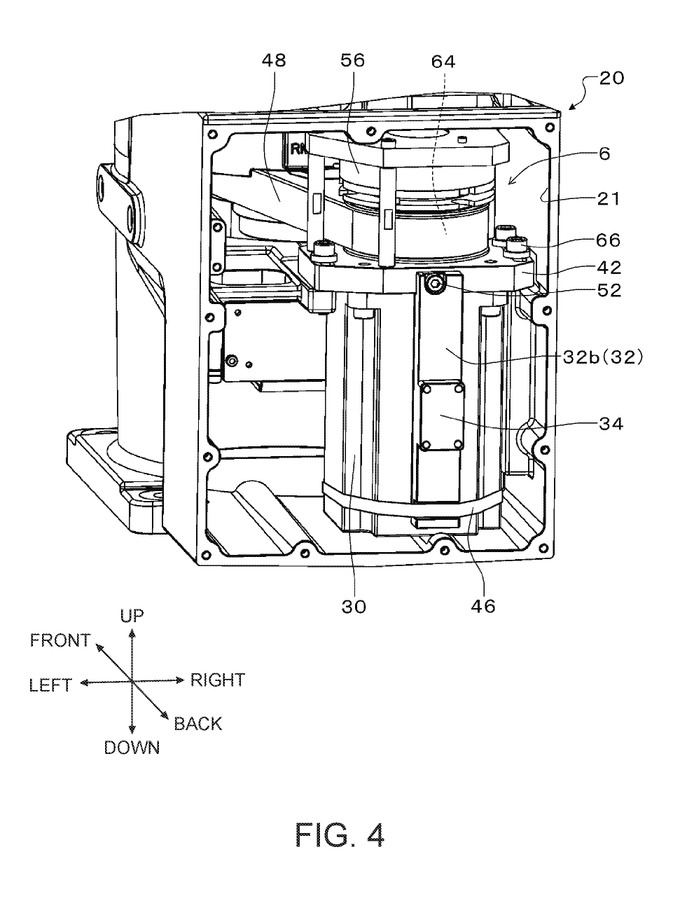

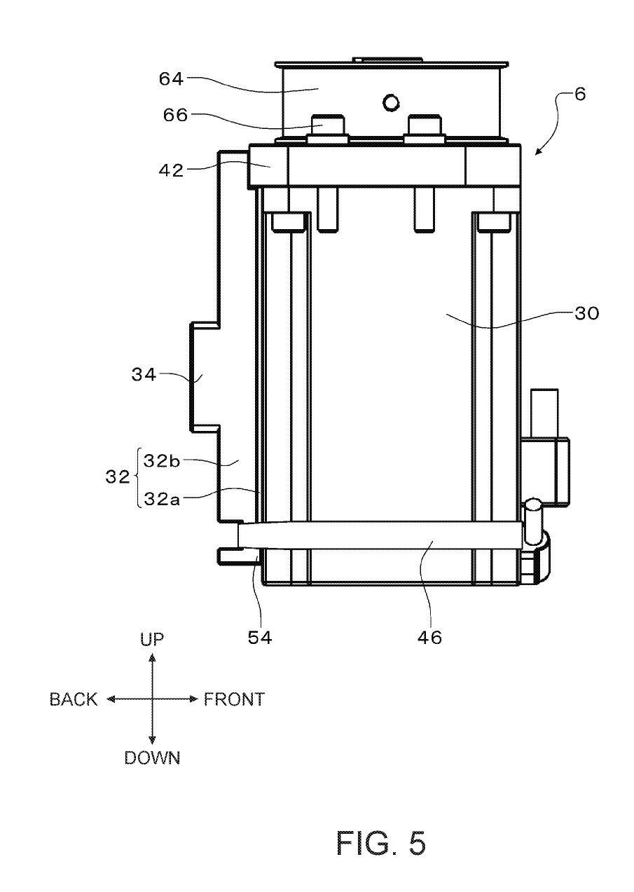

FIG. 4 is a perspective view of a state in which the cover 22 is detached from the base 20 of the embodiment. FIG. 5 shows the motor unit 6 of the embodiment as seen from the right leftward.

The motor 30 is provided inside of the base 20. The motor 30 is placed near the cover 22 of the base 20. Here, the motor 30 placed in the base 20 is cooled, and thereby, thermal expansion of the base 20 due to heat generation of the motor 30 may be reduced. The thermal expansion of the base 20 significantly affects the displacement of the arm tip end, and the reduction effect of the displacement due to the thermal expansion of the base 20 may be obtained by cooling of the motor 30. A structure in which the heat transfer member 32 for motor heat dissipation is attached directly to the motor 30 is employed, and thereby, variations in heat dissipation performance of the motor 30 due to assembly variations may be suppressed and stable heat dissipation performance may be obtained. Further, the heat transfer member 32 may be fixed to the motor 30 only by detachment of the cover 22, and the attachment work of the heat transfer member 32 may be easily performed. Furthermore, attachment and belt tension adjustment of the motor 30 may be easily performed with the heat transfer member 32 attached thereto.

The attachment of the heat transfer member 32 to the motor 30 is to fix one part of the heat transfer member 32 using a screw 52 and the other part using a cable tie 46 or the like. In this regard, a screw hole for fixing the heat transfer member 32 is provided in the motor plate 42 in advance and a clearance for passing the cable tie 46 is provided in the lower part of the motor 30, and thereby, the heat transfer member 32 may be fixed without detachment of the motor 30 from the base 20.

Note that, for the fixation of the heat transfer member 32, screws or cable ties may be used for both parts. According to the configuration, the attachment may be reliable and inexpensive. Further, it is preferable that the heat transfer member 32 is placed at the center of the motor 30. Thereby, the center of the motor 30 that generates the maximum heat may be efficiently cooled.

The robot 10 includes the cooling member 36 detachably provided in the heat transfer member 32. According to the configuration, heat dissipation performance of the heat transfer member 32 may be further improved. In the heat transfer member 32, the cooling member 36 is provided on the opposite side to the motor 30. The heat transfer member 32 includes the first part 34 for fixing the cooling member 36. The first part 34 of the heat transfer member 32 projects outward from the cover 22 surface. Regarding the amount of projection, the fixing position of the motor 30 varies due to variations of the length of the belt 48 and variations of processing accuracy of the base 20, and the first part projects by an amount of length allowing the amounts of variations.

The heat transfer member 32 includes a first heat transfer member 32a and a second heat transfer member 32b. The first heat transfer member 32a is a heat transfer sheet 32a in contact with the motor 30. According to the configuration, the heat of the motor 30 may be propagated to the second heat transfer member 32b promptly and efficiently by the heat transfer sheet 32a.

For the heat transfer sheet 32a, a material good in workability into a shape, which will be described later, is preferable, and the material not damaged by melting at a heating temperature of a heating plate, which will be described later, and not easily fractured is suitable. For example, a sheet primarily consisting of silicon (silicon sheet), a resin sheet primarily consisting of acryl or acrylic rubber, a graphite sheet primarily consisting of black lead, a metal sheet, or the like may be used.

The second heat transfer member 32b includes a stepped portion 54 for controlling the amount of compression of the heat transfer sheet 32a to be constant. According to the configuration, the stepped portion 54 comes into contact with the side surface of the motor 30, and thereby, the amount of compression of the heat transfer sheet 32a may be controlled to be constant and heat dissipation performance may be stably obtained. Further, the heat transfer sheet 32a is attached directly to the motor 30, and the work is easy.

Note that, to further improve the workability after installation, the heat transfer sheet 32a and the second heat transfer member 32b may be fixed to the motor 30 in advance. In this case, the first part 34 of the second heat transfer member 32b projects from the cover 22, however, the amount of projection may be covered by an inexpensive cover or the like.

The cooling member 36 is preferably the heat sink 36. According to the configuration, the heat transmitted from the motor 30 to the heat transfer member 32 may be dissipated from the heat sink 36 more positively. For example, the size of the heat sink 36 may be selected according to desired heat dissipation performance. As a result, the temperature rise of the heat transfer member 32 may be prevented more reliably from the motor 30.

The heat sink 36 has a function of cooling the motor 30 as the heat generating member via the heat transfer member 32. Thereby, the temperature rise of the motor 30 may be prevented. As a result, fast transportation with higher average load of the motor 30 may be addressed.

More specifically, the robot 10 has the heat transfer sheet 32a provided on the motor 30, the second heat transfer member 32b provided on the heat transfer sheet 32a, and the heat sink 36 provided on the second heat transfer member 32b. That is, the motor 30 and the heat sink 36 are joined (bonded) or in contact via the heat transfer member 32. The heat sink 36 is provided, and thereby, the heat transmitted from the motor 30 to the heat transfer member 32 may be dissipated from the heat sink 36 more positively. Accordingly, the temperature rises of the motor 30, the first heat transfer sheet 32a, and the second heat transfer member 32b may be prevented more reliably.

Further, the heat sink 36 is provided on the second heat transfer member 32b. The heat sink 36 is provided on the part (second heat transfer member 32b) integrally formed with the motor 30, and thereby, heat resistance between the heat transfer member 32 and the motor 30 is particularly smaller and the heat of the motor 30 may be dissipated more reliably via the heat transfer member 32.

The heat sink 36 has a fin for heat dissipation for improvement of the contact area with an external gas, and has a function of receiving heat from the second heat transfer member 32b and dissipating the heat.

The above described heat sink 36 is formed using a material having a higher coefficient of thermal conductivity (i.e., a highly thermal conductive material) than the coefficient of thermal conductivity of the constituent material of the motor 30 (i.e., the constituent material of the case of the motor 30). The highly thermal conductive material is not particularly limited, but includes e.g. metals (elemental metals) such as Li, Be, B, Na, Mg, Al, K, Ca, Sc, V, Cr, Mn, Fe, Co, Ni, Cu, Zn, Ga, Rb, Sr, Y, Zr, Nb, Mo, Cd, In, Sn, Sb, Cs, Ba, La, Hf, Ta, W, Tl, Pb, Bi, Ce, Pr, Nd, Pm, Sm, Eu, Gd, Tb, Dy, Ho, Er, Tm, Yb, Lu, Ag, Au, Pt, Pd, alloys containing these metals, oxides, nitrides, etc. containing these metals.

Of them, as the highly thermal conductive material, a metal material such as aluminum, copper, titanium, or stainless steel or a ceramics material such as aluminum nitride or silicon nitride is preferable. These highly thermal conductive materials have particularly higher thermal conductivity. Accordingly, the heat sink 36 may dissipate the heat of the motor 30 especially positively.

Further, the robot 10 includes the cooling member 50 detachably provided on the heat sink 36. The cooling member 50 is preferably the fan 50. According to the configuration, forceful ventilation is performed, and thereby, the motor 30 that generates a large amount of heat may be efficiently cooled. For example, the fan 50 may be selected according to desired heat dissipation performance. Note that the heat sink 36 by which desired heat dissipation performance may be obtained is provided on the second heat transfer member 32b, however, the heat sink 36 may be made smaller and the fan 50 may be provided.

As shown in FIG. 3, the fan 50 is attached to the heat sink 36. The fan 50 may be of a type that blows from inside to outside of the heat sink 36, however, is preferably of a type that blows from outside to inside of the heat sink 36.

There is a method of releasing heat to the housing of the robot 10, however, to obtain heat capacity, it is necessary to increase the volume of the casing and a problem of increase in installation area or the like arises. As one of effective means for improving the heat dissipation performance without increasing the volume, there is a method using the cooling fan 50. In accordance with the usage condition of the robot 10, an installation structure of the fan 50 easily detachable afterward may be proposed.

Returning to FIGS. 2A and 2B, the robot 10 includes a packing (sealing member) 38. The packing 38 is provided between the cover 22 and the second heat transfer member 32b of the robot 10.

The heat transfer member 32 attached to the motor 30 and the heat sink 36 fixed to the heat transfer member 32 are provided and the packing 38 is provided between the second heat transfer member 32b and the cover 22, and thereby, heat may be dissipated outside of the robot 10 with secured air-tightness inside of the robot 10.

According to the configuration, with secured air-tightness inside of the robot 10, the heat transfer member 32 is provided outside of the robot 10 and the motor 30 is cooled thereby, and thus, the heat of the motor 30 may be efficiently dissipated. Note that, also, dust emission from inside of the robot 10 may be prevented and the robot may be applied to a clean environment. Further, a dust-proof and water-proof fan may be attached to increase the heat dissipation performance.

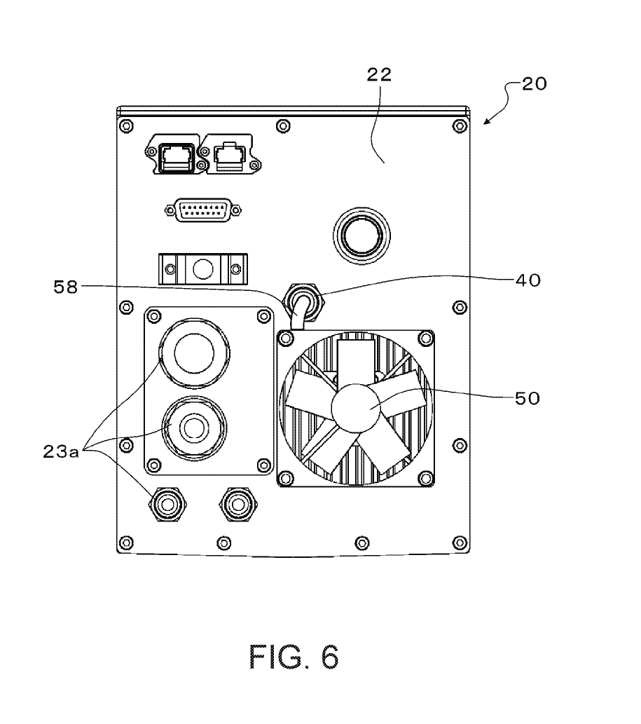

FIG. 6 shows the base 20 of the embodiment as seen from the back frontward.

The robot 10 includes a power source connecting part (power source) 40. The power source connecting part 40 supplies electric power to the fan 50 and other members via a cable 58. According to the configuration, the fan 50 is easily attached and detached from the heat sink 36. Further, it is unnecessary to newly and additionally provide another power source for fan 50 outside. Furthermore, the fan 50 may be placed in a part close to the motor 30 and higher heat dissipation performance may be obtained.

According to the embodiment, in the case where heat generation of the motor 30 is problematic, heat dissipation performance may be improved after installation. Further, in the case where the heat generation is not problematic, an inexpensive apparatus may be provided. Furthermore, the motor is placed closer to the cover 22, and thereby, the workability may be improved and the size of the second heat transfer member 32b may be made smaller (inexpensive). To meet various needs, a heat dissipation option for the motor 30 that is easily attached after installation may be provided. The robot 10 in which the motor 30 is effectively cooled and the temperature rise due to heat generation of the motor 30 may be provided.

Note that the embodiment is not limited to that described as above, but may be implemented in the following forms.

### MODIFIED EXAMPLE 1

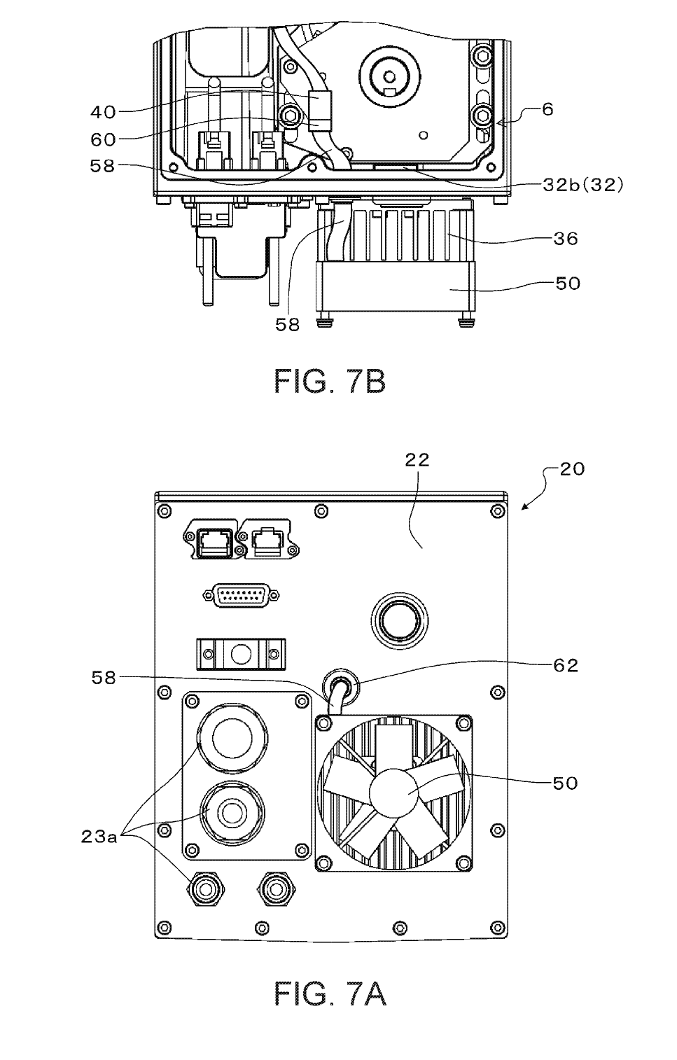

FIG. 7A shows the base 20 of the modified example from the back frontward, and FIG. 7B shows the base 20 of the modified example from the top downward. Note that, in FIG. 7B, the illustration of f the upper case of the base 20 is omitted.

In the modified example, the cover 22 maybe detached and the power of the fan 50 maybe supplied from the power source connecting part (power source) 40 inside of the base 20 via an inexpensive resin connector 60 and the cable 58. A cut may be made in the center part of a grommet with film 62 and the wiring of the cable 58 may be passed through the cut.

### MODIFIED EXAMPLE 2

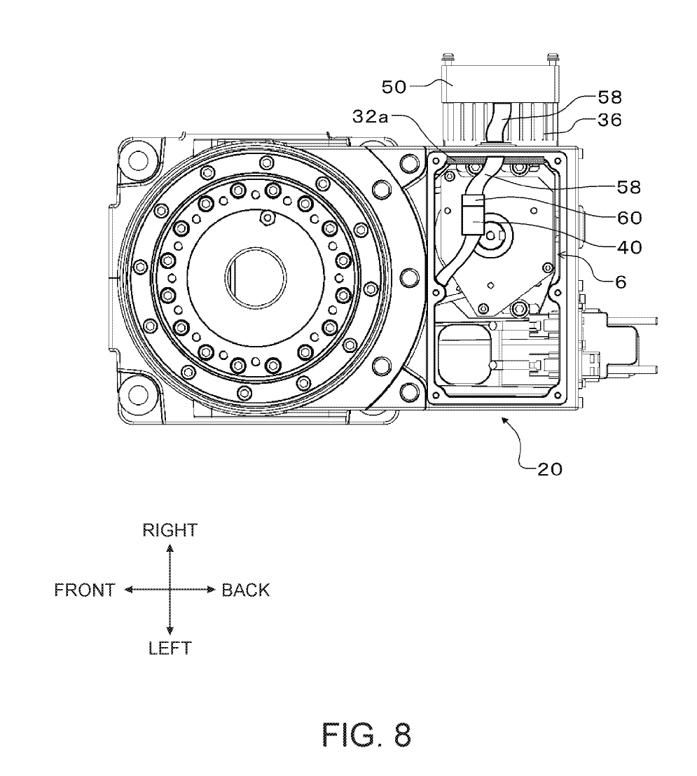

FIG. 8 shows the base 20 of the modified example from the top downward. Note that, in FIG. 8, illustration of the upper case of the base 20 is omitted.

In the base 20 of the modified example, the heat sink 36 is detachably provided on an external case of the base 20. The fan 50 is provided on the heat sink 36. The heat transfer sheet 32a is provided between the motor 30 and the case of the base 20.

According to the modified example, in the case where heat generation of the motor 30 is problematic, heat dissipation performance may be improved after installation. Further, in the case where the heat generation is not problematic, an inexpensive apparatus may be provided.

### MODIFIED EXAMPLE 3

A simple blower such as the fan 50 is preferably used for the cooling member, however, water cooling may be employed. The cooling member may have a heat exchanger such as a heat pipe, a thermoelectric conversion element such as a Peltier element, or the like in place of the heat sink 36 or may have a combination of them.

### MODIFIED EXAMPLE 4

The first heat transfer member 32a is not limited to the heat transfer sheet, but may be a heat transfer material e.g. a heat transfer double-sided tape, a heat transfer pad, heat transfer grease.

### MODIFIED EXAMPLE 5

The heat generating member 30 is not limited to the motor, but may be a member that generates heat such as a reducer or a brake. According to the configuration, the temperature rise of the reducer, brake, or the like may be prevented more reliably.

### MODIFIED EXAMPLE 6

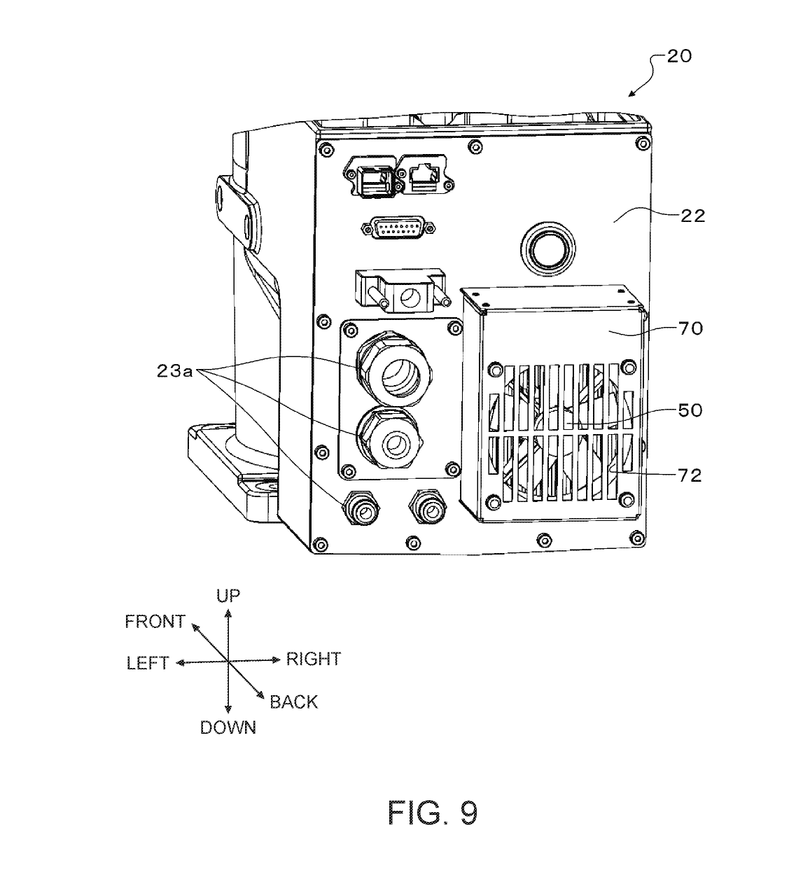

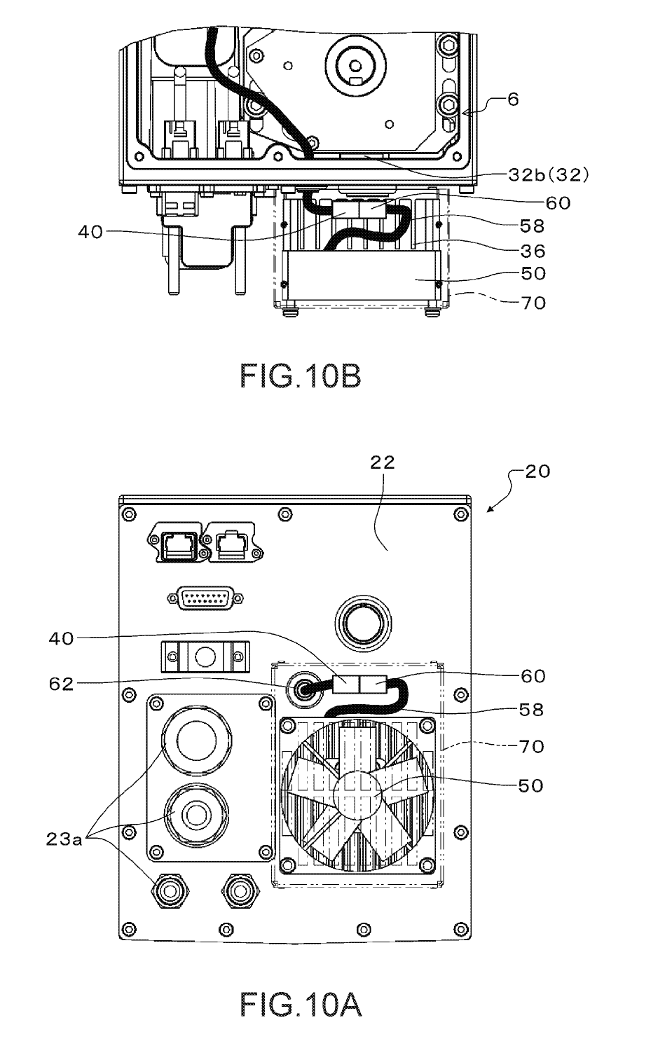

FIG. 9 is a perspective view showing a state in which a protective cover member 70 is attached to the base 20 of the modified example. FIG. 10A shows the base 20 of the modified example from the back frontward, and FIG. 10B shows the base 20 of modified example from the top downward. Note that, in FIG. 10B, the illustration of the upper case of the base 20 is omitted.

In the base 20 of the modified example, the protective cover member 70 is detachably provided outside of the base 20. The protective cover member 70 in a rectangular parallelepiped box shape that protects the fan 50, the heat sink 36, and the cable 58 is provided. In side of the protective cover member 70, the fan 50, the heat sink 36, and the cable 58 are placed. The fan 50, the heat sink 36, and the cable 58 are housed in an internal space formed by the flat protective cover member 70 having a shallow bottom and the cover 22.

The protective cover member 70 prevents the user from touching the heat sink 36 at a high temperature and the fan 50 rotating at a high speed. The protective cover member 70 is completely covered so that the user can not touch it.

The protective cover member 70 may be attached from outside of the base 20. In other words, the protective cover member 70 is easily detachable from the base 20.

Many slots 72 for air circulation by the fan 50 are provided in the protective cover member 70. The width of the slot 72 is about 5 millimeters so that the finger of the user may not enter the slot. Note that the slots 72 may be small diameter holes. The size of the small diameter hole is about 5 millimeters in diameter so that the finger of the user may not enter the hole. Or, the slots 72 and the small diameter holes may be a mesh. The mesh may be a wire mesh or a plastic mesh formed by knitting plastic thread.

Note that the power source connecting part 40 and the connector 60 may be provided inside of the protective cover member 70. As shown in FIGS. 10A and 10B, the power source connecting part 40, the connector 60, the fan 50, the heat sink 36, and the cable 58 are housed in an internal space formed by the flat protective cover member 70 having the shallow bottom and the cover 22. According to the configuration, the connector 60 of the fan 50 is detachable from the power source connecting part 40 outside of the base 20, and thereby, the fan 50 may be replaced without detachment of the upper case of the base 20.

As above, the robot and the robot system according to the invention are explained based on the illustrated embodiments, however, the invention is not limited to those. The configurations of the respective parts may be replaced by arbitrary configurations having the same functions. Further, other arbitrary configurations may be added thereto.

In the above described embodiment, the first surface as a plane (surface) to which the robot (base) is fixed is a plane (surface) in parallel to the horizontal plane, however, the invention is not limited to that. For example, a plane (surface) inclined with respect to the horizontal plane and the vertical plane may be employed or a plane (surface) in parallel to the vertical plane may be employed. That is, the first rotation axis may be inclined with respect to the vertical direction and the horizontal direction or parallel to the horizontal direction.

The robot according to the invention is not limited to the vertical articulated robot, and the same advantages may be obtained in a horizontal articulated robot, parallel link robot, dual-arm robot, or the like. Further, the robot according to the invention is not limited to the six-axis robot, and the same advantages may be obtained in a robot of seven or more axes or five or less axes. Furthermore, the robot according to the invention is not limited to the armed robot (robot arm) as long as the robot has an arm, but may be another type of robot e.g. a legged walking (running) robot or the like.

The entire disclosure of Japanese Patent Application No. 2016-007672, filed Jan. 19, 2016 is expressly incorporated by reference herein.

What is claimed is:

1. A robot comprising:
a heat generating member; and
a heat transfer member detachably provided on the heat generating member,
wherein the heat transfer member has a first part located outside of the robot.

2. The robot according to claim 1, wherein the heat generating member is a motor.

3. The robot according to claim 1, further comprising a cooling member detachably provided on the heat transfer member.

4. The robot according to claim 1, wherein the cooling member includes a heat sink.

5. The robot according to claim 1, wherein the cooling member includes a fan.

6. The robot according to claim 1, further comprising:
a base; and
an arm provided on the base,
wherein the heat generating member is provided inside of the base.

7. The robot according to claim 1, wherein the heat transfer member has a first heat transfer member and a second heat transfer member, and
the first heat transfer member is a heat transfer sheet in contact with the heat generating member.

8. The robot according to claim 1, further comprising a sealing member,
wherein the sealing member is provided between a casing of the robot and the second heat transfer member.

9. The robot according to claim 1, further comprising a power source,
wherein the power source supplies electric power to the cooling member and another member.

10. A robot comprising a cooling member detachably provided outside of the robot.

11. A robot system comprising:
the robot according to claim 1; and
a control apparatus that controls the robot.

12. A robot system comprising:
the robot according to claim 2; and
a control apparatus that controls the robot.

13. A robot system comprising:
the robot according to claim 3; and
a control apparatus that controls the robot.

14. A robot system comprising:
the robot according to claim 4; and
a control apparatus that controls the robot.

15. A robot system comprising:
the robot according to claim 5; and
a control apparatus that controls the robot.

16. A robot system comprising:
the robot according to claim 6; and
a control apparatus that controls the robot.

17. A robot system comprising:
the robot according to claim 7; and
a control apparatus that controls the robot.

18. A robot system comprising:
the robot according to claim 8; and
a control apparatus that controls the robot.

19. A robot system comprising:
the robot according to claim 9; and
a control apparatus that controls the robot.

20. A robot system comprising:
the robot according to claim 10; and
a control apparatus that controls the robot.
